(19) United States
(12) Patent Application Publication
(10) Pub. No.: US 2026/0307394 A1
(43) Pub. Date: Oct. 8, 2026

(54) INKJET RECORDING APPARATUS

(71) Applicant: KYOCERA Document Solutions Inc., Osaka (JP)

(72) Inventors: Takuma ARAKI, Osaka (JP); Yuna NIIMI, Osaka (JP)

(73) Assignee: KYOCERA Document Solutions Inc., Osaka (JP)

(21) Appl. No.: 19/575,363

(22) Filed: Mar. 23, 2026

(30) Foreign Application Priority Data
Apr. 4, 2025 (JP) 2025-062659

(51) Int. Cl. B41J 2/175

(52) U.S. Cl. CPC B41J 2/17523; B41J 2/17566; B41J 2/17596; B41J 2002/17576

(57) ABSTRACT

An inkjet recording apparatus includes a recording head, a tank, and a liquid flow passage. The recording head has a plurality of nozzles through which ink is ejected onto a recording medium. The tank temporarily stores the ink fed from a container and feeds the stored ink to the recording head. The liquid flow passage connects together the container and the tank and, through it, the ink circulates. The liquid flow passage includes a feed flow passage and a branch flow passage. The feed flow passage is connected to a bottom part of the tank and feeds the ink from the container to the tank. The branch flow passage branches off the feed flow passage and is connected to a top part of the container. The branch flow passage is transparent.

### INCORPORATION BY REFERENCE

This application is based on Japanese Patent Application No. 2025-062659 filed on Apr. 4, 2025.

### BACKGROUND

The present disclosure relates to an inkjet recording apparatus.

Conventional inkjet recording apparatuses include a recording head, a tank, a liquid flow passage, and a float sensor. The recording head has a plurality of nozzles through which ink is ejected onto a recording medium. The tank temporarily stores the ink fed from a container and feeds the stored ink to the recording head. The liquid flow passage connects together the container and the tank and, through it, the ink circulates. The float sensor senses the level of the liquid surface of the ink in the tank.

Inconveniently, with conventional inkjet recording apparatuses, the tank is configured with a material with high light blocking properties to protect the stored ink, so in an emergency such as when the float sensor is broken or when a printer is off, it may be impossible to check the amount of ink remaining in the tank.

An object of the present disclosure is to provide an inkjet recording apparatus that permits the checking of the amount of ink remaining in a tank in an emergency.

### SUMMARY

According to one aspect of the present disclosure, an inkjet recording apparatus includes a recording head, a tank, and a liquid flow passage. The recording head has a plurality of nozzles through which ink is ejected onto a recording medium. The tank temporarily stores the ink fed from a container and feeds the stored ink to the recording head. The liquid flow passage connects together the container and the tank and, through it, the ink circulates. The liquid flow passage includes a feed flow passage and a branch flow passage. The feed flow passage is connected to a bottom part of the tank and feeds the ink from the container to the tank. The branch flow passage branches off the feed flow passage and is connected to a top part of the container. The branch flow passage is transparent.

This and other objects of the present disclosure, and the specific benefits obtained according to the present disclosure, will become apparent from the description of embodiments which follows.

### BRIEF DESCRIPTION OF THE DRAWINGS

FIG. 1 is an illustrative diagram showing an outline configuration of a printer as an inkjet recording apparatus according to one embodiment of the present disclosure.

FIG. 2 is a plan view of a recording portion provided in the printer according to the embodiment.

FIG. 3 is a block diagram of the printer according to the embodiment.

FIG. 4 is an illustrative diagram showing a liquid feeding mechanism in the printer according to the embodiment.

FIG. 5 is an illustrative diagram showing the tank in the printer according to the embodiment.

### DETAILED DESCRIPTION

### 1. Construction of an Inkjet Recording Apparatus

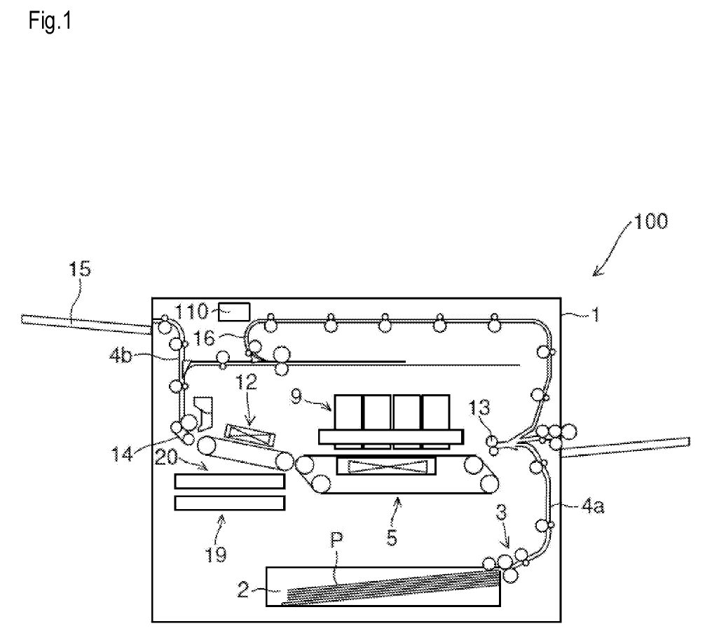

An embodiment of the present disclosure will be described below with reference to the accompanying drawings. FIG. 1 is an illustrative diagram showing an outline configuration of a printer 100 as an inkjet recording apparatus according to one embodiment of the present disclosure. The printer 100 includes a sheet feed cassette 2 as a sheet storage portion. The sheet feed cassette 2 is arranged in a lower part inside a printer body 1. The sheet feed cassette 2 stores inside it sheets of paper P as one example of a recording medium.

Downstream of the sheet feed cassette 2 along the sheet conveyance direction, that is, to the upper right of the sheet feed cassette 2 in FIG. 1, a sheet feeding portion 3 is arranged. From the sheet feeding portion 3, the sheets P are fed out, one by one separately, to the upper right of the sheet feed cassette 2 in FIG. 1.

The printer 100 has a first sheet conveyance passage 4a. The first sheet conveyance passage 4a is located to the upper right of the sheet feed cassette 2, that is, in the direction in which this feeds sheets. A sheet P fed out of the sheet feed cassette 2 is conveyed by the first sheet conveyance passage 4a vertically upward along a side face of the printer body 1.

At the downstream end of the first sheet conveyance passage 4a along the sheet conveyance direction, a pair of registration rollers 13 is provided. Closely downstream of the pair of registration rollers 13 along the sheet conveyance direction, a sheet conveyance portion 5 and a recording portion 9 are arranged. The sheet P fed out of the sheet feed cassette 2 passes through the first sheet conveyance passage 4a and reaches the pair of registration rollers 13. The pair of registration rollers 13 feeds out the sheet P toward the sheet conveyance portion 5 while correcting a skew of the sheet P and coordinating timing with ink ejection operation in the recording portion 9.

The sheet P fed out to the sheet conveyance portion 5 by the pair of registration rollers 13 is conveyed by a conveyance belt (not shown) to a position opposite the recording portion 9 (in particular, recording heads 17a to 17c, which will be described later). The recording portion 9 ejects ink onto the sheet P and thereby records an image on the sheet P. At this time, the ejection of ink by the recording portion 9 is controlled by a control portion 110 within the printer 100.

The control portion 110 includes a CPU, a storage portion, and other electronic circuits and electronic components (none is illustrated). The CPU controls the operation of different components in the printer 100 and performs processes related to the functions of the printer 100 based on control programs and data stored in the storage portion. The storage portion is configured as, for example, a combination of a non-volatile storage device such as a program ROM (read-only memory) and a data ROM, and a volatile storage device such as a RAM (random-access memory).

Downstream of (in FIG. 1, at the left of) the sheet conveyance portion 5 along the sheet conveyance direction, a drying portion 12 is arranged. The sheet P having the image recorded on it by the recording portion 9 is fed to the drying portion 12. The ink ejected onto the surface of the sheet P dries while passing through the drying portion 12.

Downstream of the drying portion 12 along the sheet conveyance direction, near the left side face of the printer body 1, a decurler 14 is provided. The sheet P having ink dried in the drying portion 12 is fed to the decurler 14, which corrects a curl that has developed in the sheet P.

Downstream of (in FIG. 1, above) the decurler 14 along the sheet conveyance direction, a second sheet conveyance passage 4b is provided. When duplex printing is not performed, the sheet P having passed through the decurler 14 passes through the second sheet conveyance passage 4b and is discharged to a sheet discharge tray 15 provided on the left side face of the printer 100, outside it.

In an upper part of the printer body 1, above the recording portion 9 and the drying portion 12, a reversing conveyance passage 16 for duplex printing is provided. When duplex printing is performed, the sheet P that has undergone recording on one side (first side) and that has passed through the drying portion 12 and the decurler 14 is fed through the second sheet conveyance passage 4b to the reversing conveyance passage 16.

The sheet P fed to the reversing conveyance passage 16 has its conveyance direction switched for recording on the other side (second side). The sheet P then passes through an upper part of the printer body 1 to be fed rightward, and is then fed via the pair of registration rollers 13 to the sheet conveyance portion 5 again, this time with the second side up. In the sheet conveyance portion 5, the sheet P is conveyed to a position opposite the recording portion 9, where the recording portion 9 ejects ink to record an image on the second side. The sheet P having undergone recording on both sides passes through the drying portion 12, the decurler 14, and the second sheet conveyance passage 4b in this order and is discharged to the sheet discharge tray 15.

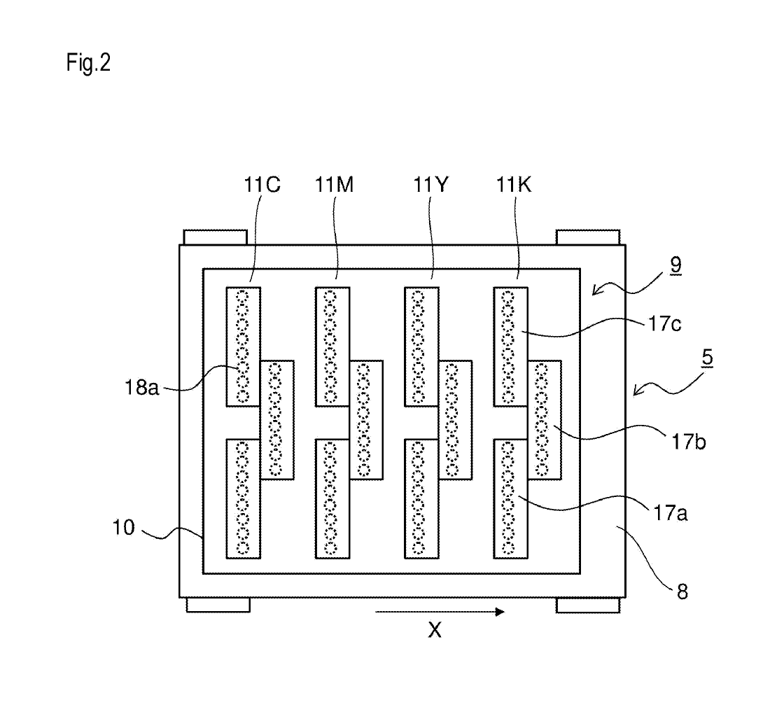

Below the drying portion 12, a maintenance unit 19 and a cap unit 20 are arranged. When performing purging, the maintenance unit 19 moves horizontally to under the recording portion 9; there it wipes off the ink pushed out through nozzles 18a (see FIG. 2) in recording heads 17a to 17c and collects the ink wiped off. Purging denotes operation of forcibly pushing ink out through the nozzles 18a in the recording heads 17a to 17c to remove ink with increased viscosity, foreign matter, air bubbles, and the like inside the nozzles 18a.

When capping the ink ejection surface of the recording heads 17a to 17c, the cap unit 20 moves horizontally to under the recording portion 9 and then moves upward to be attached to the bottom surface of the recording heads 17a to 17c.

FIG. 2 is a plan view of the recording portion 9 in the printer 100. The recording portion 9 includes a head housing 10 and line heads 11C, 11M, 11Y, and 11K held on the head housing 10. These line heads 11C to 11K are supported at such a height as to form a predetermined interval (e.g., 1 mm) relative to the conveyance surface of the conveyance belt (not shown) and, as shown in FIG. 1, each have a plurality of (here, three) recording heads 17a to 17c arranged in a staggered row along the sheet width direction (the up-down direction in FIG. 1), which is orthogonal to the sheet conveyance direction (arrow-X direction).

The recording heads 17a to 17c in the line heads 11C to 11K are supplied with inks of four colors (cyan, magenta, yellow, and black) from ink tanks (not shown) respectively according to the colors for which the line heads 11C to 11K are intended.

In response to a control signal from the control portion 110 (see FIG. 1), the recording heads 17a to 17c eject inks from the nozzles 18a toward a sheet P being conveyed on, by being held by suction on, the conveyance surface of the conveyance belt (not shown) according to image data received from an external computer. As a result, on the sheet P on the conveyance belt, a color image having inks of four colors, namely cyan, magenta, yellow, and black, laid over each other is formed.

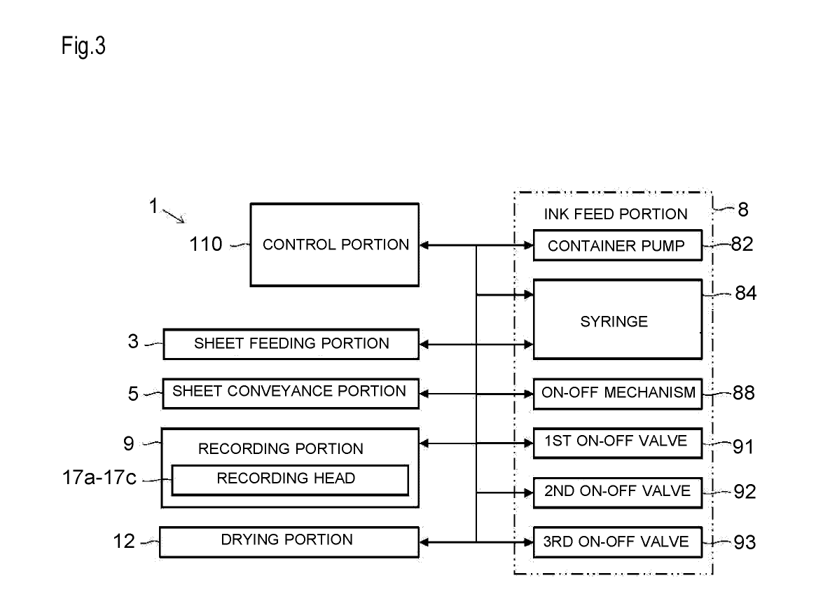

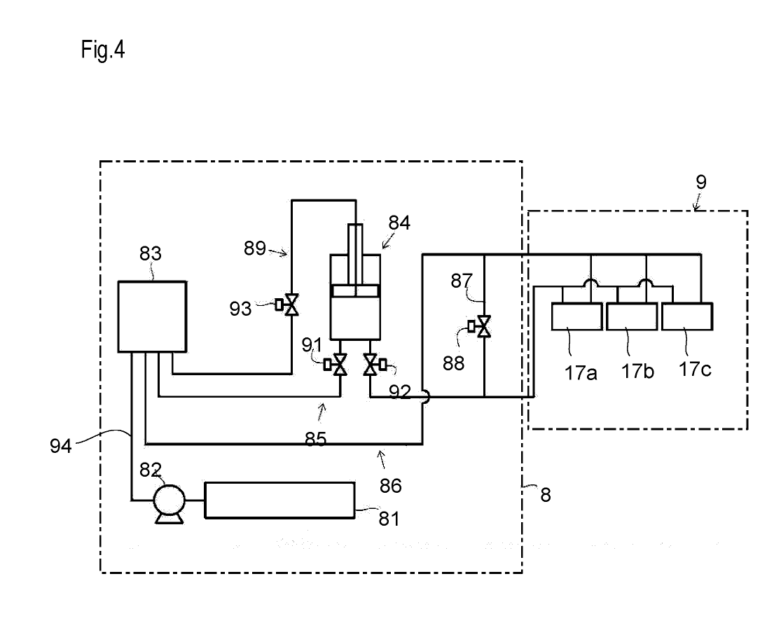

FIG. 3 is a block diagram of the printer 100 and FIG. 4 is an illustrative diagram of a liquid feeding mechanism in the printer 100. The printer 100 includes ink feed portions 8. The ink feed portions 8 are provided one for each of the four line heads 11C to 11K. In the following description, the suffixes distinguishing different colors will be omitted.

Between the ink feed portions 8 and the recording heads 17a to 17c, there are provided valve members (not shown) that open an ink flow passage in a connected state and close the ink flow passage in a disconnected state.

The ink feed portion 8 includes a container 81, a container pump 82, a tank 83, a syringe 84, a first flow passage 85, a second flow passage 86, a third flow passage 89, a communication flow passage 87, an on-off mechanism 88, a first on-off valve 91, a second on-off valve 92, a third on-off valve 93, and a liquid flow passage 94. That is, the printer 100 includes the tank 83 and the liquid flow passage 94.

The container 81 is removably mountable in the printer body 1. The container 81 stores ink to be fed to the recording heads 17a to 17c.

The container pump 82 is arranged downstream of the container 81 in the ink circulation direction. The container pump 82 sucks in the ink in the container 81 and ejects it towards the tank 83. The operation of the container pump 82 is controlled by the control portion 110.

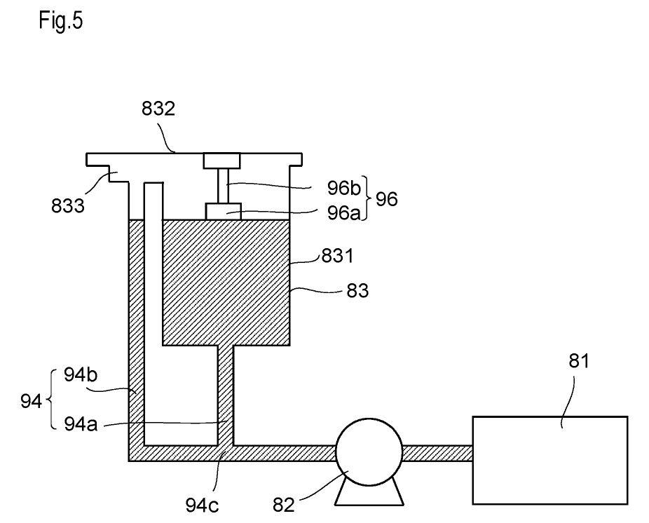

The tank 83 is arranged downstream of the container pump 82 in the ink circulation direction. The tank 83 temporarily stores the ink fed from the container 81 and feeds the stored ink to the recording heads 17a to 17c. The tank 83 is provided with an ink amount sensor 96 (see FIG. 5). The ink amount sensor 96 can be any of sensors of optical, capacitive, electrode, differential pressure, and float types, and senses the level of the ink surface in the tank 83. In this embodiment, as the ink amount sensor 96, a float type sensor is used (see FIG. 5).

The control portion 110 receives a sensing signal from the ink amount sensor 96 in the tank 83. When the amount of ink in the tank 83 sensed by the ink amount sensor 96 falls below a predetermined value, the control portion 110 controls the container pump 82 to feed ink from the container 81 to the tank 83. The amount of ink fed from the container 81 to the tank 83 is controlled, for example, by controlling the driving time of the container pump 82. If the amount of ink in the tank 83 sensed by the ink amount sensor 96 does not exceed the predetermined value even after the driving time of the container pump 82 has exceeded a certain period of time, the control portion 110 judges that the amount of ink in the container 81 is zero.

The syringe 84 is arranged downstream of the tank 83 in the ink circulation direction, upstream of the recording heads 17a to 17c in the ink circulation direction. The ink flows from the tank 83 into the syringe 84 and flows out of it toward the recording heads 17a to 17c.

The third flow passage 89 extends from the syringe 84 to the tank 83. The third flow passage 89 is an air flow passage that discharges air in the syringe 84 to the tank 83.

The third on-off valve 93 is arranged in the third flow passage 89. The third on-off valve 93 opens and closes the third flow passage 89. The third on-off valve 93 is configured, for example, as an electromagnetic valve and is controlled to open and close by the control portion 110. The control portion 110 opens the third on-off valve 93 when discharging the air in the syringe 84.

During image recording to the sheet P, a recording pressure acts on the ink under a water head pressure. In contrast, for example, during maintenance, the control portion 110 can apply a maintenance pressure higher than the recording pressure to the ink by pressing ink out of the syringe 84.

The first flow passage 85, the second flow passage 86, and the communication flow passage 87 are ink flow passages through which the ink circulates from the tank 83 via the recording heads 17a to 17c to the tank 83. The first flow passage 85 is an ink flow passage that the ink circulates from the tank 83 via the syringe 84 to the recording heads 17a to 17c.

The first on-off valve 91 is arranged in the first flow passage 85, upstream of the syringe 84 in the ink circulation direction. The second on-off valve 92 is arranged in the first flow passage 85, downstream of the syringe 84 in the ink circulation direction. The first flow passage 85 is, for example, a tube of rubber and can be deformed by being bent or sagged. The first and second on-off valves 91 and 92 are controlled to open and close by the control portion 110. The first on-off valve 91 opens and closes the first flow passage 85 between the syringe 84 and the tank 83. The second on-off valve 92 opens and closes the first flow passage 85 between the syringe 84 and the recording heads 17a to 17c.

The second flow passage 86 is an ink flow passage through which the ink circulates from the recording heads 17a to 17c to the tank 83.

Through the communication flow passage 87, an upstream part of the recording heads 17a to 17c in the ink circulation direction in the first flow passage 85 communicates with a downstream part of the recording heads 17a to 17c in the ink circulation direction in the second flow passage 86.

The on-off mechanism 88 is arranged in the communication flow passage 87. The on-off mechanism 88 is configured, for example, as an electromagnetic valve and is controlled to be open and close by the control portion 110. The on-off mechanism 88 opens and closes the communication flow passage 87.

When a process for replacement with different ink is started on the printer 100, the control portion 110 discharges the ink in the tank 83 from the recording heads 17a to 17c. Meanwhile, the control portion 110 makes the syringe 84 perform push-out operation to discharge ink from the recording heads 17a to 17c. The amount of ink in the tank 83 is, for example, sensed by the ink amount sensor 96 in the tank 83.

The control portion 110 makes the syringe 84 perform push-out operation to discharge the ink in the syringe 84 from the recording heads 17a to 17c. Thus, the control portion 110 discharges the ink in the tank 83 and in the ink flow passage from the recording heads 17a to 17c.

The control portion 110 drives the container pump 82 to feed ink from the container 81 to the tank 83.

The control portion 110 performs air vent operation for the syringe 84 and loads ink in the syringe 84. For example, to perform air vent operation for the syringe 84, the control portion 110 closes the first and second on-off valves 91 and 92, opens the third on-off valve 93, and performs push-out operation with the syringe 84. Thus, the air in the syringe 84 is discharged via the third flow passage 89.

When ink is loaded in the syringe 84, the control portion 110 opens the first and third on-off valves 91 and 93 and closes the second on-off valve 92. Then the control portion 110 performs sucking operation with the syringe 84. Thus, the ink is loaded from the tank 83 to the syringe 84.

The control portion 110 controls the on-off mechanism 88 to open the communication flow passage 87 and performs first circulation operation to circulate ink through the ink flow passage. Meanwhile the control portion 110 performs sucking operation and push-out operation with the syringe 84. Thus, the ink circulates through the ink flow passage.

The control portion 110 controls the on-off mechanism 88 to close the communication flow passage 87 and performs sucking operation and push-out operation with the syringe 84. Thus, the ink circulates through the ink flow passage.

The control portion 110 performs air vent operation for the syringe 84, ink loading operation with the syringe 84, and ink circulation operation with the ink flow passage with the communication flow passage 87 closed.

The control portion 110 discharges (purges) ink from the recording heads 17a to 17c. Meanwhile, the control portion 110 makes the syringe 84 perform push-out operation to discharge (purge) ink from the recording heads 17a to 17c.

The control portion 110 discharges ink in the tank 83 and the syringe 84 from the recording heads 17a to 17c. Meanwhile, the control portion 110 makes the syringe 84 perform push-out operation to discharge ink from the recording heads 17a to 17c.

FIG. 5 is an illustrative diagram showing the tank 83. In FIG. 5, the first flow passage 85, the second flow passage 86, and third flow passage 89 are not shown. In this embodiment, the tank 83 has a storage portion 831 that stores ink and a lid portion 832 that closes an upper end face of the storage portion 831. An upper part of the storage portion 831 projects to a side to form a projection portion 833.

The tank 83 is formed of a metal material or a resin material with high flame retardancy and light blocking properties. Thus, the tank 83 is not transparent, so it does not allow visual checking of the ink level from outside. In the lid portion 832, a communication hole (not shown) is formed for communication between the inside and outside of the tank 83.

In this embodiment, the ink amount sensor 96 is a float sensor having a float 96a and a rail 96b. The rail 96b extends in the up-down direction and the float 96a is supported on the rail 96b so as to be movable in the up-down direction. The float 96a floats on the liquid surface of ink and moves up and down according to the level of the liquid surface. The ink amount sensor 96 senses the level of the liquid surface of the ink in the tank 83 based on the position of the float 96a.

The container 81 and the tank 83 are connected together via the liquid flow passage 94 through which the ink is circulated. The liquid flow passage 94 has a feed flow passage 94a and a branch flow passage 94b. The feed flow passage 94a is connected to a bottom part of the tank 83 and feeds the ink from the container 81 to the tank 83. The branch flow passage 94b branches off the feed flow passage 94a and is connected to a bottom part of the projection portion 833. That is, the branch flow passage 94b is connected to a top part of the tank 83.

The liquid flow passage 94 is, for example, a tube of rubber and can be deformed by being bent or sagged. The branch flow passage 94b is transparent and extends in the up-down direction. The liquid surface of the ink in the branch flow passage 94b is at the same height as the liquid surface of the ink in the tank 83. This allows visual checking of the level of the liquid surface of the ink in the transparent branch flow passage 94b and thus allows sensing of the amount of ink remaining in the tank 83. Thus, when the ink amount sensor 96 is broken or the printer 100 is turned off, the amount of ink remaining in the tank 83 can be correctly sensed by checking the level of the liquid surface of the ink in the branch flow passage 94b.

The container pump 82 is arranged upstream, in the ink circulation direction, of a branch portion 94c where the branch flow passage 94b branches off the feed flow passage 94a and feeds the ink from the container 81 to the tank 83.

When with the first, second, and third on-off valves 91, 92, and 93 closed, the container pump 82 is driven to keep feeding ink to the tank 83, the liquid surface in the tank 83 rises. Meanwhile, when the ink level exceeds the bottom face of the projection portion 833, the ink in the tank 83 flows into the branch flow passage 94b. The ink returned to the branch flow passage 94b then returns to the feed flow passage 94a. That is, part of the ink fed via the feed flow passage 94a to the tank 83 returns through the branch flow passage 94b to the feed flow passage 94a. This allows the ink in the branch flow passage 94b to circulate, preventing the ink from drying and coagulating at the liquid surface in the branch flow passage 94b by being exposed to air. This prevents degradation of the function of the branch flow passage 94b as an indicator for sensing the amount of ink remaining in the tank 83.

The present disclosure can be implemented in any manner other than as in the embodiment described above, and allows for any modifications without departure from the spirit of the present disclosure. The effects of the present disclosure will be described more specifically below by way of examples. The present disclosure, however, is not limited in any way by those examples. While in this embodiment the branch flow passage 94b is connected to the bottom face of the tank 83, it can instead be connected to a bottom part of the side face of the storage portion 831.

What is claimed is:

1. An inkjet recording apparatus comprising:
a recording head that has a plurality of nozzles through which ink is ejected onto a recording medium;
a tank that temporarily stores the ink fed from a container, the tank feeding the ink stored therein to the recording head; and
a liquid flow passage that connects together the container and the tank, the ink circulating through the liquid flow passage,
wherein
the liquid flow passage includes:
a feed flow passage that is connected to a bottom part of the tank and that feeds the ink from the container to the tank; and
a branch flow passage that branches off the feed flow passage and that is connected to a top part of the container, and
the branch flow passage is transparent.

2. The inkjet recording apparatus according to claim 1, further comprising:
a container pump that is arranged in the feed flow passage, upstream of a branch portion where the branch flow passage branches off the feed flow passage, the container pump feeding the ink from the container to the tank.

3. The inkjet recording apparatus according to claim 2, wherein
as the container pump is driven, part of the ink fed via the feed flow passage to the tank returns through the branch flow passage to the feed flow passage.

4. The inkjet recording apparatus according to claim 1, further comprising:
an ink amount sensor that senses a level of a liquid surface of the ink in the tank.
